(19) United States
(12) Patent Application Publication
(10) Pub. No.: US 2002/0186995 A1
(43) Pub. Date: Dec. 12, 2002

(54) Multiple pigment application pencil

(76) Inventor: Irina Iosilevich, Boca Raton, FL (US)

Correspondence Address: FRANK L. KUBLER, 13261 S.W. 54th Court, Miramar, FL, 33027, US

(21) Appl. No.: 09/876,905

(22) Filed: Jun. 8, 2001

(51) Int. Cl. B43K 27/02; B05C 1/00

(52) U.S. Cl. 401/19; 401/17

(57) ABSTRACT

A pigment application pencil includes a column of pigment material having a composition which readily rubs onto a contacting surface and being divided into several discrete color regions of differing pigment color, the column having at least one longitudinal flat side including portions of at least two of the color regions; and an outer layer of pencil cover material; so that sliding contact of two color regions on the flat side permits even and uniform parallel application of contrasting pigments along a well defined straight or curving line.

### BACKGROUND OF THE INVENTION

1. Field of the Invention

The present invention relates generally to the field of pigment delivery devices, such as for applying cosmetics. More specifically the present invention relates to a pigment application pencil including a unified column of pigment material having a composition which readily rubs onto a contacting surface and is divided radially into discrete color regions of differing pigment color, the column having at least one longitudinal flat side which exposes portions of at least two of the regions, and an optional outer layer of pencil cover material. Exposure of two or more color regions on a single flat side permits even and uniform parallel application of contrasting pigments along a well defined straight or curving line. The pigment material is preferably eyeliner or lipliner, but may be any of many other pigment materials such as a crayon or grease pencil. The pencil cover material is preferably wound paper or plastic which is progressively unwound, by hand at intervals in which the pigment material is worn flush with the cover material.

The circumference of the unified column is preferably formed entirely of such flat sides intersecting at sharp corners, the preferred column cross-sectional shapes including but not limited to triangular, square, pentagonal and hexagonal. These general geometric shapes are still preferably truncated longitudinally at corners to provide alternating long flat sides and short flat sides. Thus, for example, a triangular cross-section becomes a triangle truncated at each corner so that each corner ends in a longitudinal short flat side.

2. Description of the Prior Art

There have long been eyeliner pencils, crayons and other pigment material line application devices which can trace a line of a single color, and of a single given width. A problem with these prior application devices has been that forming adjacent parallel lines cannot be done with ease or precision, since one must use a separate application device loaded with a different pigment and try to trace a line beside and following the first traced pigment color line. Another problem is that there is no provision for drawing lines of various specific widths.

It is thus an object of the present invention to provide a pigment application pencil having a pigment column made up of at least two discrete pigment sections exposed at a single pigment column side for precise drawing of a pigment line of immediately adjacent multiple colors.

It is another object of the present invention to provide such a pencil which provides pigment material application columns having one or more flat sides to draw a line of one or multiple colors of a given, uniform width.

It is still another object of the present invention to provide such a pencil which provides a pigment material application column having multiple flat sides of differing uniform widths as well as sharp corners for drawing lines of differing specific widths.

It is finally an object of the present invention to provide such a pencil which is easy to handle and economical to manufacture.

### SUMMARY OF THE INVENTION

The present invention accomplishes the above-stated objectives, as well as others, as may be determined by a fair reading and interpretation of the entire specification.

A pigment application pencil is provided, including a unified column of pigment material having a composition which readily rubs onto a contacting human tissue surface and being divided into several discrete color regions of differing pigment color, the column having at least one longitudinal flat side including portions of at least two of the color regions; and an outer layer of pencil cover material; such that sliding contact of two color regions on the flat side with a human tissue surface permits even and uniform parallel application of contrasting pigments along a well defined straight or curving line. The discrete color regions are preferably divided radially.

The pigment material preferably is one of: eyeliner and lipliner. The pencil cover material preferably includes wound flexible sheet material for progressively unwinding and removing as the pigment material is worn flush with the cover material. The circumference of the unified column preferably is formed entirely of several of the flat sides intersecting at corners. The column cross-sectional shape preferably is one of: triangular, square, pentagonal and hexagonal. The cross-sectional geometric shapes preferably are truncated at the corners to define short flat sides between long flat sides, so that the long and short flat sides alternate.

A pigment application pencil is provided, including a column of pigment material having a composition which readily rubs onto a contacting surface and being divided radially into several discrete color regions of differing pigment color, the column having at least one longitudinal flat side including portions of at least two of the color regions; and an outer layer of pencil cover material; so that sliding contact of two color regions on the flat side permits even and uniform parallel application of contrasting pigments along a well defined straight or curving line.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a segment of a pigment column having a triangular cross-section with truncated corners and three radially divided color regions.

FIG. 2 is a perspective view of a segment of a pigment column having a square cross-section with truncated corners and four radially divided color regions.

FIG. 3 is a perspective view of a segment of a pigment column having a square cross-section with truncated corners and five radially divided color regions.

FIG. 4 is a perspective view of a segment of a pigment column having a hexagonal cross-section with truncated corners and six radially divided color regions.

FIG. 5 is a perspective view of a segment of a pigment column having a triangular cross-section and three radially divided color regions.

FIG. 6 is a perspective view of a segment of a pigment column having a square cross-section and four radially divided color regions.

FIG. 7 is a perspective view of a segment of a pigment column having a pentagonal cross-section and five radially divided color regions.

FIG. 8 is a perspective view of a segment of a pigment column having a hexagonal cross-section and six radially divided color regions.

FIG. 9 is a pencil having a pigment column with a triangular cross-section having truncated corners and three radially divided color regions, the pencil tracing a line with two adjacent discrete longitudinal color portions deposited by two of the color regions.

FIG. 10 is a front view of a representation of a human eye showing a dual color line on the skin immediately below the eye traced by the inventive pencil having an eyeliner pigment column.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

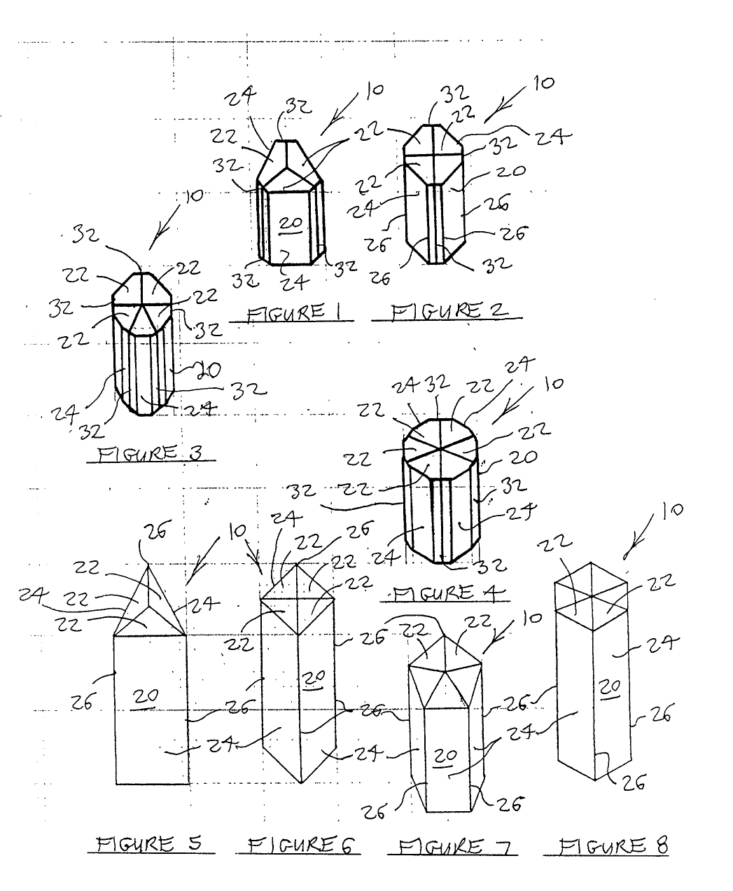

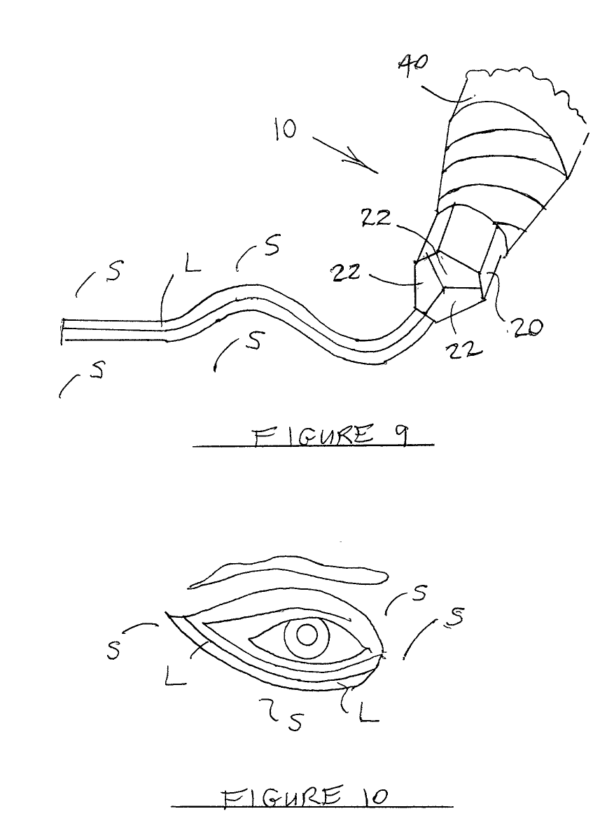

Referring to FIGS. 1-10, a pigment application pencil 10 is disclosed, including a column 20 of pigment material having a composition which readily rubs onto a moving, contacting surface S such as of human tissue and is divided into discrete color regions 22 of differing pigment color, the column 20 having at least one longitudinal flat side 24 including portions of at least two of the regions 22, and an optional outer layer 40 of pencil cover material. The discrete color regions 22 are preferably, although not necessarily, divided from each other along radial column 20 lines. Exposure of two or more color regions 22 on a single flat side 24 permit even and uniform parallel application of contrasting pigments along a well defined straight or curving line L. The column is preferably unified and singular, but alternatively may be a bundle of pigment material sticks of differing colors. The pigment material is preferably eyeliner or lipliner, but may be any of many other pigment materials such as crayon material. The pencil cover material is preferably wound paper or plastic which is progressively unwound by hand at intervals in which the pigment material is worn flush with the cover material. The unwinding cover material at the distal end of the pencil leaves a substantially conical outer layer shape, as is known in conventional grease pencil design.

The circumference of unified column 20 preferably consists entirely of such flat sides 24 intersecting at sharp corners 26, the preferred column 20 cross-sectional shapes including but not limited to triangular, square, pentagonal and hexagonal. A single narrow line of pigment material can be applied by dragging a corner 26 over a surface to be marked. These general geometric shapes are still preferably truncated at longitudinal corners 26 to provide alternating long flat sides 24 which can be dragged over a surface to be marked to produce pigment lines of full width and short flat sides 32, which can be dragged over a surface to be marked to produce pigment lines of medium width. Thus a triangular cross-section becomes a triangle truncated at each corner 26 so that each corner 26 ends in a longitudinal short flat side 32. See FIGS. 1 and 9.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A pigment application pencil, comprising:
a unified column of pigment material having a composition which readily rubs onto a contacting human tissue surface and being divided into a plurality of discrete color regions of differing pigment color, said column having at least one longitudinal flat side including portions of at least two of the color regions;
and an outer layer of pencil cover material;
such that sliding contact of two color regions on said flat side with a human tissue surface permits even and uniform parallel application of contrasting pigments along a well defined straight or curving line.

2. The pencil of claim 1, wherein said plurality of discrete color regions are radially divided.

3. The pencil of claim 1, wherein said pigment material is one of: eyeliner and lipliner.

4. The pencil of claim 1, wherein said pencil cover material comprises wound flexible sheet material for progressively unwinding and removing as said pigment material is worn flush with said cover material.

5. The pencil of claim 1, wherein the circumference of said unified column is formed entirely of a plurality of said flat sides intersecting at corners.

6. The pencil of claim 5, wherein said column cross-sectional shape is one of: triangular, square, pentagonal and hexagonal.

7. The pencil of claim 5, wherein said cross-sectional geometric shapes are truncated at said corners to define short flat sides between long flat sides, such that said long and short flat sides alternate.

8. A pigment application pencil, comprising:
a column of pigment material having a composition which readily rubs onto a contacting surface and being divided into a plurality of discrete color regions of differing pigment color, said column having at least one longitudinal flat side including portions of at least two of the color regions;
and an outer layer of pencil cover material;
such that sliding contact of two color regions on said flat side permits even and uniform parallel application of contrasting pigments along a well defined straight or curving line.

9. The pencil of claim 8, wherein said plurality of discrete color regions are radially divided.
